(19) United States
(12) Patent Application Publication
(10) Pub. No.: US 2007/0016913 A1
(43) Pub. Date: Jan. 18, 2007

(54) Computer device driver and method of operation

(76) Inventors: Wael M. Ibrahim, Cypress, TX (US); Chi W. So, Houston, TX (US); David J. Grimme, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/181,550

(22) Filed: Jul. 13, 2005

(51) Int. Cl. G06F 9/46

(52) U.S. Cl. 719/321

(57) ABSTRACT

A computer device driver comprises a computer operating system including a structure configured to communicate with a device driver interface using a predefined protocol, and a device including a memory storing an embedded driver with device information. In one aspect, the memory is configured to store physical information and functional information regarding the device. In another aspect, the operating system is configured to import at least a portion of the device information and build a device driver. In another aspect, the memory is configured to store a driver for each of a plurality of operating systems. Advantages of the invention include flexible device driver implementation and deployment across a wide range of computing operating systems and environments.

### BACKGROUND

Computers and peripheral devices continue to evolve, thereby driving a marketplace demand to connect a wide variety of devices to computers. Examples of such devices include video cards, network cards, pointing devices like a mouse, digital storage devices like memory cards, digital cameras, digital music players, and a plethora of other devices. Many such devices require the awareness of the computer's operating system in order to function properly.

Conventional computer systems employ device drivers to detect and communicate with various devices. However, there are many different operating systems on the market and the number of available devices is rapidly growing. This expansion in the number of operating systems and devices complicates coordination between operating system companies and device companies, which can often lead to inefficient operation of the devices.

What is needed is a computer device driver architecture and method that can be applied to computer systems for operation on any number of different operating systems with any number of different devices.

### SUMMARY

The invention provides a flexible device driver implementation that can be deployed across a wide range of computing operating systems and environments, and can work in conjunction with a wide range of devices.

An exemplary computer device driver comprises a computer operating system including a structure configured to communicate with a device driver interface using a predefined protocol, and a device including a memory storing an embedded driver with device information. In one aspect, the memory is configured to store physical information and functional information regarding the device. In another aspect, the operating system is configured to import at least a portion of the device information and build a device driver. In another aspect, the memory is configured to store a driver for each of a plurality of operating systems, and the driver can be executed directly from the device.

### DRAWINGS

The present invention is illustrated by way of example, and not by way of limitation, in the figures of the accompanying drawings and in which like reference numerals refer to similar elements and in which:

FIG. 1 depicts a computer system with a number of connected devices;

FIG. 2A depicts an exemplary device according to an embodiment of the invention;

FIG. 2B depicts an exemplary embedded driver code according to an embodiment of the invention;

FIG. 3 depicts an exemplary software and hardware stack according to an embodiment of the invention;

FIG. 4 is a flowchart depicting an exemplary method according to an embodiment of the invention;

FIG. 5 is a flowchart depicting an exemplary method according to an embodiment of the invention; and

FIG. 6 is a flowchart depicting an exemplary method according to an embodiment of the invention.

### DETAILED DESCRIPTION

The present invention is described in detail with reference to exemplary embodiments thereof as illustrated in the accompanying drawings. In the following description, numerous specific details are set forth in order to provide a description of the best mode of the invention. It will be apparent, however, to one skilled in the art, that the present invention may be practiced without some or all of these specific details.

Various embodiments are described herein, including apparatus, methods and techniques for performing the invention. It should be kept in mind that the invention anticipates articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention also anticipates apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

A. Architecture

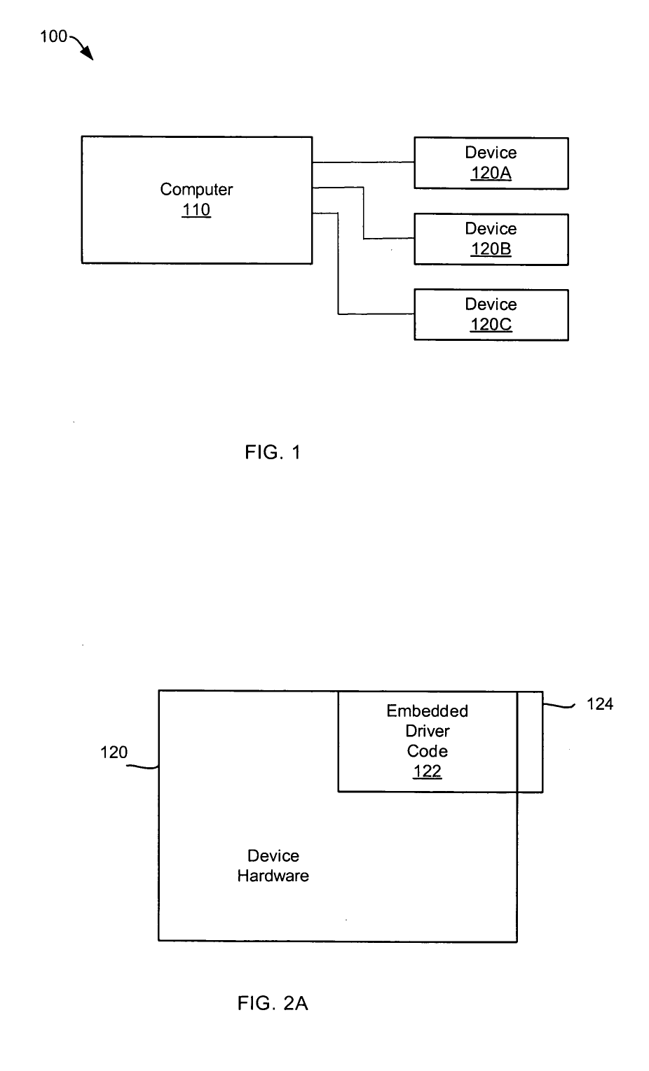

FIG. 1 depicts a computer system with a number of connected devices. An exemplary architecture according to an embodiment of the invention includes a computer 110 running a particular operating system, for example, Linux, HP-UX, or Windows. One or more hardware devices 120A-120C are connected to the computer and a driver is used to communicate between the operating system and the device. The device is connected to the computer, for example, via PCI bus, PCI Express, AGP port, serial port, parallel port, gaming port, USB port, infrared, wireless, or other connection. Conventional techniques for installing a device driver, described in the background, do not provide sufficient flexibility for communicating with devices over a wide range of computing environments. The invention provides several aspects to achieve communication with devices while maintaining flexibility across a wide range of computing environments.

The exemplary embodiment of the invention enables the device hardware to notify the computer operating system of information relating to its capabilities and requirements. This information can include aspects such as physical parameters, for example, the number of ports and types of connectors on the device, the type of on-board processor, the amount of memory, and so forth. The information may include operational parameters like the memory address space, 10 range, DMA channel, IRQ and other such information. The information can also include aspects such as functional parameters, for example, the device's ability to gather different types of data (e.g. dots per inch on a scanner, or pixel resolution in a camera), or perform certain functions (e.g. burning a blank CD or DVD disk in one of a variety of different formats). In one implementation, the information provides the operating system with enough information to build a native device driver.

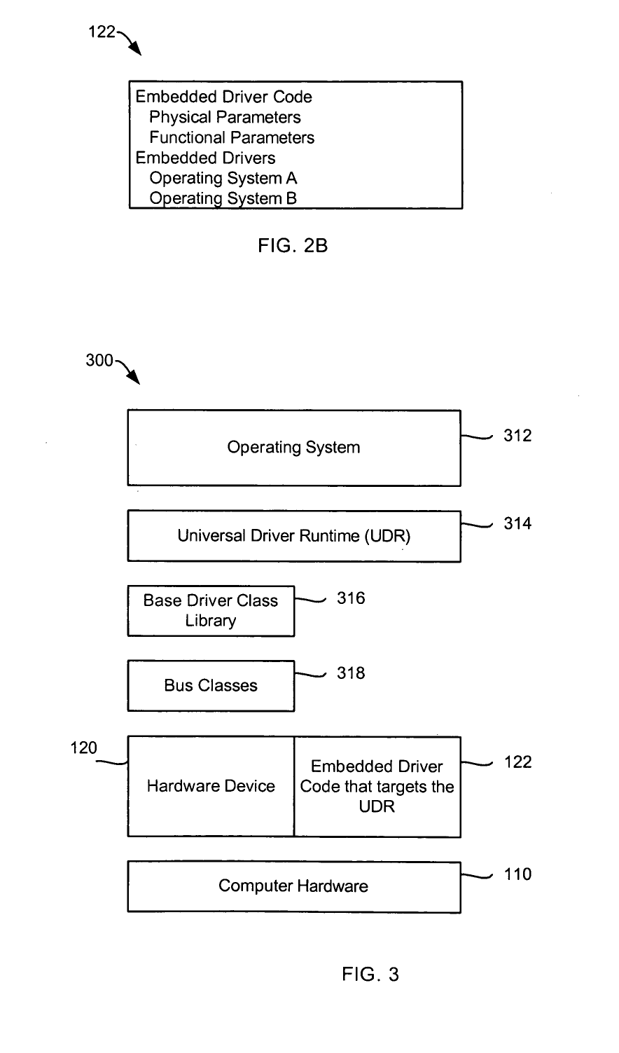

FIG. 2A depicts an exemplary device 120 according to an embodiment of the invention. The device includes a memory 122 and a connector 124. The memory stores embedded driver code, and is, for example, a non-volatile memory such as a flash ROM. FIG. 2B depicts an exemplary embedded driver code according to an embodiment of the invention. The driver code contains information regarding the device, for example, physical parameters and functional parameters. The embedded driver code can also contain embedded drivers for one or more operating systems. In one aspect, the firmware driver code contains embedded drivers for one or more operating systems. The operating system has a choice of using one of several available implementations. For example, if the operating system cannot build a native driver, it may choose to use the firmware driver code, given that the operating system incorporates the features to support the universal interface implementation.

The invention provides several modes under which the invention supports device communications. These modes are implemented in conjunction with the existing computing environment, or in conjunction with a modification thereof to include a universal device driver interface layer.

FIG. 3 depicts an exemplary software and hardware stack according to an embodiment of the invention. The figure is a logical view of the computing environment. The operating system 312 is coupled to a universal driver runtime 314, which is supported by a base driver class library 316 and bus classes 318. The hardware device 120 and embedded driver code 122 is implemented on the device. In one aspect, the embedded driver code targets the universal driver runtime for compatibility. The computer hardware 110 is coupled to the device 120.

The embedded code can be updated either by replacing the memory 122 in the device 120 or by other means of updating the code that resides in memory.

Having described exemplary embodiments and aspects of the invention architecture, several modes of operation are supported and described in detail below.

B. Modes of Operation

1. Native Mode

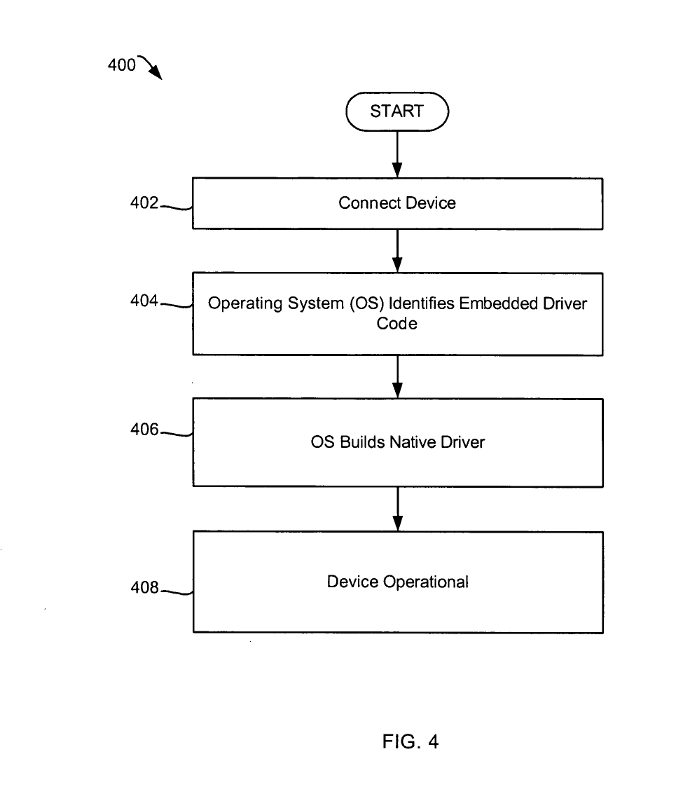

FIG. 4 is a flowchart depicting an exemplary method according to an embodiment of the invention demonstrating the native mode. In native mode, the operating system builds and installs the device driver, which then behaves as a native device driver. This mode provides automated device driver development by the operating system, which is enabled by the operating system's awareness of its own architecture and the underlying subsystems that interact with hardware. Another aspect that enables this mode is the hardware's natural awareness of its resource requirements. With respect to the device information, for example, memory on the device is programmed by the manufacturer to have fields in a structure that describe the device information, such as requirements and rules for using the device (e.g. see FIG. 2B). In one aspect, the computer system BIOS is also extended to accommodate this mode. The device hardware conveys some of its requirements (interrupt lines, DMA channels, etc . . . ) to the operating system through configuration registers and either System BIOS ACPI or direct operating system calls. The operating system assigns physical resources through mechanisms such as ACPI, and can also provide more run-time capabilities. The data structures defining the calls that the operating system will build can be communicated to the operating system through either method. These data structures include the functional capabilities of the card and the interfaces to them, as well as the registers to program a device to send or receive data from the specified bus linear addresses.

Referring to FIG. 4 flowchart 400, the device is connected to the computer system in step 402. In step 404, the operating system identifies the embedded code in the device memory. In step 406, the operating system retrieves the device information necessary to build a native device driver. In step 408, the device is operational using the native driver driver.

2. Universal Interface Mode

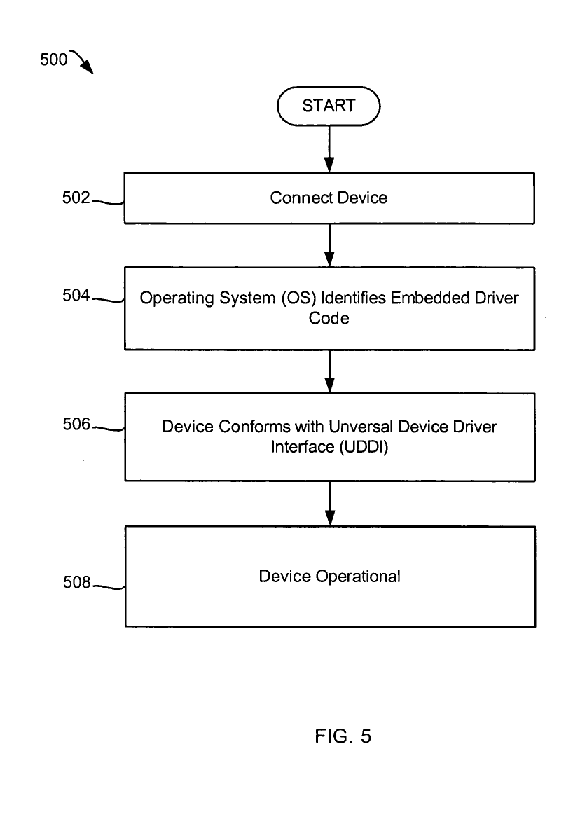

FIG. 5 is a flowchart depicting an exemplary method according to an embodiment of the invention demonstrating the universal interface mode. In this mode, the invention includes a Universal Device Driver binary interface. The hardware exports an interface the Universal Device Driver. The operating system incorporates a compatible subsystem that communicates with the universal device driver. The implementation of the invention employs universally available functionalities and interfaces that are exposed by the firmware residing on the hardware in order to define how the operating systems can use the resources. These resources are often referred to as input-output controls (IOCTLS), for example ReadFile, WriteFile, OpenCreate, and other resources. This mode is enabled under the architecture depicted in FIG. 3 showing the hardware and software stack 300.

Referring to FIG. 5 flowchart 500, the device is connected to the computer system in step 502. In step 504, the operating system identifies the embedded code in the device memory. The operating system includes a universal device drive interface (UDDI) that enables it to communicate with a device that exports a UDDI interface, as depicted in step 506. In step 508, the device is operational using the Universal Device Driver Interface (UDDI) driver.

3. Shadowed Execution Mode

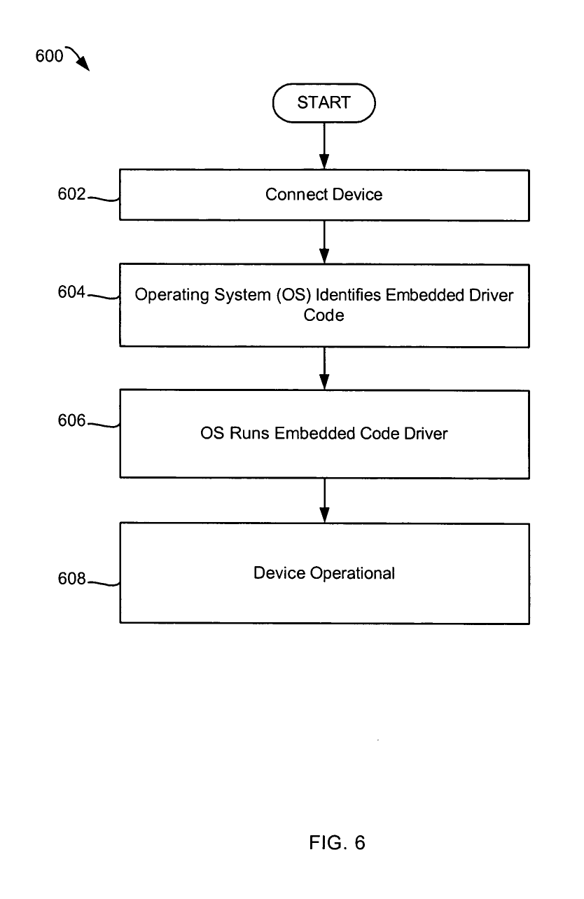

FIG. 6 is a flowchart depicting an exemplary method according to an embodiment of the invention demonstrating the shadowed execution mode. This mode implements a fast RAM as part of the memory 124 in order to shadow the contents of the embedded code. The operating system executes the device driver from the RAM component on the device so there is no need for the operating system to build a separate device driver. Performance is still very good since the RAM is fast and the operating system can treat the RAM as an extension of the main computer RAM.

Referring to FIG. 6 flowchart 600, the device is connected to the computer system in step 602. In step 604, the operating system identifies the embedded code in the device memory. In step 606, the operating system uses the embedded code as a driver to communicate with the device. In step 608, the device is operational with the operating system using the driver on-board the device.

4. Legacy Mode

This mode is provided for backwards compatibility with legacy systems. This mode is a conventional technique for creating a device driver and using that driver to communicate with the device.

### C. CONCLUSION

Advantages of the invention include flexible device driver implementation and deployment across a wide range of computing operating systems and environments. By implementing certain aspects of the invention, manufacturers only need to maintain a single source code for all computing platforms rather than a different source code for each platform. Installation of peripheral devices is simplified since the operating system does not need an existing device driver, but rather, the operating system can obtain relevant information from the device in order to build a driver or use an on-board firmware implementation of the device driver. These features create a true plug and play platform that is flexible to meet the needs of the operating system and devices.

While the invention has been described in terms of several embodiments and the best mode, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer device driver comprising:
a computer operating system including a structure configured to communicate with a device driver interface using a predefined protocol; and
a device including a memory storing an embedded driver with device information.

2. The computer device driver of claim 1, wherein:
the operating system is configured to import at least a portion of the device information and build a device driver.

3. The computer device driver of claim 1, wherein:
the memory is configured to store physical information, operational information and functional information regarding the device.

4. The computer device driver of claim 2, wherein:
the memory is configured to store physical information, operational information and functional information regarding the device.

5. The computer device driver of claim 1, wherein:
the memory is configured to store a driver for each of a plurality of operating systems.

6. The computer device driver of claim 2, wherein:
the memory is configured to store a driver for each of a plurality of operating systems.

7. The computer device driver of claim 3, wherein:
the memory is configured to store a driver for each of a plurality of operating systems.

8. The computer device driver of claim 4, wherein:
the memory is configured to store a driver for each of a plurality of operating systems.

9. The computer device driver of claim 1, wherein:
the device includes a connector adapted for coupling with a computer system executing the computer operating system.

10. A computer device comprising:
a connector adapted for coupling with a computer system;
a memory configured to store information regarding the device and a driver for each of a plurality of operating systems.

11. The device driver of claim 10, wherein:
the memory is configured to store physical information, operational information and functional information regarding the device.

12. The computer device of claim 10 for use with a computer system having an operating system, wherein:
the connector is configured to export at least a portion of the device information to the operating system in order for the operating system to build a device driver.

13. A method of communicating with a computer device using a computer with an
operating system comprising the steps of:
probing the device to retrieve information regarding the device from a memory on-board the device;
building a driver based on the information regarding the device; and
communicating with the device using the driver.

14. The method of claim 13, wherein:
the memory is configured to store physical information, operational information and functional information regarding the device, and the probing step includes the step of retrieving physical information, operational information and functional information regarding the device.

15. The method of claim 13, wherein:
the step of building a driver includes the step of using the device information to build a universal device driver compatible with the computer system.

16. A method of communicating with a computer device using a computer with an operating system comprising the steps of:
probing the device to identify an embedded driver; and
communicating with the device using the embedded driver.

17. The method of claim 16, wherein:
the probing step includes the step of retrieving physical information, operational information and functional information regarding the device; and
the communicating step includes the steps of communicating physical information, operational information and functional information regarding the device.

18. A computer device driver comprising:
a computer operating system including means for communicating with a device driver interface using a predefined protocol; and
means for storing an embedded driver with device information.

19. The computer device driver of claim 18, wherein:
the means for storing an embedded driver include means for storing physical information, operational information and functional information regarding the device.

20. The computer device driver of claim 18, further comprising:
a device including the means for storing an embedded driver, and further including means for coupling with a computer system executing the computer operating system.
